(19) United States
(12) Patent Application Publication
(10) Pub. No.: US 2010/0057562 A1
(43) Pub. Date: Mar. 4, 2010

(54) System and method for mobile match mapping

(76) Inventor: Ronen Gabbay, Kfar Saba (IL)

Correspondence Address: FOLEY & LARDNER LLP, 777 EAST WISCONSIN AVENUE, MILWAUKEE, WI, 53202-5306, US

(21) Appl. No.: 12/231,490

(22) Filed: Sep. 3, 2008

(51) Int. Cl. G06Q 30/00

(52) U.S. Cl. 705/14.52; 705/1

(57) ABSTRACT

A system and method of mobile matchmaking is provided enabling real-time management, filtering, prioritization, mapping, and interaction of and between location-based resources, such as member resources (persons), and affiliate resources (e.g., third party businesses and advertisers). Resources in the vicinity of a user are displayed on at least one of a mobile application map and a website map, providing the user with a dynamically comprehensive and detailed “matchmaking map.” Various embodiments enable prioritization, contact/interaction with, and management, in real-time, of those resources, (member and/or affiliate resources). Various icons representative of the resources are displayed on the matchmaking map, where the icons can be selected and shortened and/or detailed profiles of the resources are presented. Furthermore, various embodiments provide the ability for a user to survey the activity/matchmaking “scene” of a future destination/location to be traveled to and/or create one or more activity itineraries for future travel in advance.

### FIELD OF THE INVENTION

The present invention relates generally to location-based services. In particular, the present invention relates to real-time management, filtering, prioritization, mapping, and interaction between location-based resources.

### BACKGROUND OF THE INVENTION

Conventional matchmaking services for individuals interested in finding other individuals with compatible characteristics and/or interests to engage in, e.g., dating, sports-related activities such as tennis, etc., utilize a “bulletin board” approach to effectuate a connection between two individuals. For example, various web-based services provide a forum or a virtual congregation room where an individual may “post” a message indicating his/her desire to have coffee, see a movie, play tennis, etc., with another individual with a similar desire. If another such individual discovers the message posting, he/she may respond to the message posting and the individuals may further communicate via email, instant messaging, chat room, etc. to make arrangements to meet.

Other web-based matchmaking services provide a web-based interface that allows subscribers to list certain characteristics and/or preferences related to desired activities and post a profile on the web site. An interested subscriber may perform searches for other subscribers whose characteristics/preferences match those of the interested subscriber. Alternatively, a subscriber may browse profiles of other registered subscribers to determine the existence of registered subscribers that he/she may be interested in pursuing romantically, engaging in one or more activities with, etc. The subscriber may then effectuate contact with those registered subscribers of interest via, e.g., email, instant messaging, or other proprietary communication method supported by the web site.

Still other conventional matchmaking services provide another form of virtual meeting room, whereby subscribers can leave voicemail introductions on a telephonic server or repository. Subscribers can obtain access into the telephonic server or repository and listen to one or more available voicemail introductions as well as voicemail responses to their own voicemail introductions, if any have been left by other subscribers. If, for example, a response voicemail is appealing to a subscriber, that subscriber may forward his/her contact information to the subscriber that left the response voicemail and a telephonic conversation can be effectuated, a face-to-face meeting can be set up, etc.

As the use of mobile location-based services has grown, the above-described matchmaking services have been implemented in a mobile/cellular context. For example, a user can register his/her mobile device. When other users that have registered their mobile devices are in the vicinity of each other, alerts are sent to the users' respective mobile devices to notify them that other users that may wish to engage in activities are nearby. Further still and in addition to the conventional one-on-one matchmaking services, other systems and methods provide advertising and promotional services that track users and their entertainment habits. That is, a user may authorize a venue to profile him/her in relation to the venue. Other users can be shown those users that are in attendance at that venue, which may encourage the user to also attend that particular venue. Other systems and methods allow a salesperson to know where like salespeople are located in an attempt to promote competition among the salespeople.

### SUMMARY OF THE INVENTION

Various embodiments provide a system and method of mobile matchmaking providing real-time management, filtering, prioritization, mapping, and interaction of and between location-based resources. Resources can include member resources, such as persons, as well as affiliate resources, including but not limited to, e.g., third party businesses, advertisers, etc. Resources in the vicinity of a user are displayed on at least one of a mobile application map and a website map, thus providing the user with a dynamically comprehensive and detailed “matchmaking map.” Various icons representative of the resources are displayed on the matchmaking map, where the icons can be selected and shortened and/or detailed profiles of the resources are presented. Interaction/contact can also be initiated with one or more member and/or affiliate resources. Various embodiments enable the user to prioritize, interact with, and manage, in real-time, those resources. Furthermore, various embodiments provide the ability for a user to survey the activity “scene” of a future destination/location to be traveled to and/or create one or more romantic itineraries for future travel in advance.

Moreover, various embodiments provide the ability for a user to perform real-time/on-demand filtering of resources, e.g., on the basis of any category, including qualitative variables, such as subjective rankings attributed to resources by other users (e.g., references). Resources can be prioritized and graphically differentiated with different identifiers, such as icons, colors, and shapes, for example, based on any category or characteristic, including qualitative variables.

Although certain features and advantages are described herein, it will be appreciated that the teachings below may be used to implement systems and methods which do not necessarily have any of these features and advantages, but which have other features and advantages.

### BRIEF DESCRIPTION OF THE DRAWINGS

FIG. 1 is a flow chart illustrating processes performed in a matchmaking service in accordance with various embodiments of the present invention;

FIG. 2a is an exemplary component model overview diagram of components with which various embodiments of the present invention are implemented;

FIG. 2b is an exemplary server side component model overview diagram of server side components with which various embodiments of the present invention are implemented;

FIG. 3 is a diagram of client side component modules illustrating representative classes in accordance with various embodiments of the present invention;

FIG. 4 is a relational diagram illustrating domain object models of various system entities utilized to implement various embodiments of the present invention;

FIG. 5a is a relational diagram illustrating a data model of system tables for storing various entities and objects used to implement various embodiments of the present invention;

FIG. 5b is a diagram illustrating additional system table for storing various entities and objects used to implement various embodiments of the present invention;

FIG. 6 is a flow chart illustrating processes performed by system entities in a matchmaking service scenario in accordance with various embodiments of the present invention;

FIG. 7 is an overview diagram of a system modules architecture in accordance with various embodiments of the present invention;

FIGS. 8a-8d are exemplary web-based graphical user interfaces utilized by a user in accordance with various embodiments of the present invention;

FIGS. 9a-9k are exemplary mobile application-based graphical user interfaces utilized by a user in accordance with various embodiments;

FIG. 10 is an exemplary map display populated with resource icons in accordance with various embodiments of the present invention;

FIGS. 11a-11b are exemplary webpages utilized by a user in accordance with one embodiment of the present invention;

FIG. 11c is an exemplary screenshot of a scheduling/whereabouts feature utilized by a user in accordance with various embodiments of the present invention; and

FIG. 11d is an exemplary itinerary created in accordance with various embodiments.

### DETAILED DESCRIPTION OF THE PREFERRED EMBODIMENTS

A matchmaking system in accordance with various embodiments provides a matchmaking service for real-time management, filtering, prioritization, mapping, and interaction of and between location-based resources. Relevant resources (e.g., matching users and related third party providers such as activity-related businesses) in the vicinity of a user are displayed on a mobile map, thus providing the user with a dynamically comprehensive and detailed “matchmaking map.” Various embodiments enable the user to prioritize, interact with, and manage, in real-time, those resources.

Various embodiments may be embodied on various platforms and/or as an application operating on various devices. In accordance with one embodiment, the above features can be provided to a user via a mobile application implemented on a cellular or mobile device having location capabilities, e.g., Global Positioning System (GPS), cellular positioning system (CPS). Alternatively or in conjunction with the cellular/GPS device, a web-based system that hosts a web site can be also be utilized to achieve the features of various embodiments. Users may interact with the resources via voice communication, email, Short Messaging Service (SMS), Instant Messaging (IM), etc.

Although various embodiments provide real-time and dynamic mapping of\resources according to, e.g., a user's current location, various embodiments also allow a user to survey the activity “scene” and/or create one or more itineraries for future travel in advance. That is, various embodiments virtually locate the user in a location to be traveled to as if the user were already at that particular location. Thus, the user is afforded the opportunity to manage in real-time, filter, prioritize, map, and interact with and between location-based resources in an area as the user arrives in that area or that the user will travel to even before the user is in that area using, for example, the web-based system.

Moreover, various embodiments provide the ability for a user to perform real-time/on-demand filtering of resources, e.g., on the basis of any category, including qualitative variables, such as subjective rankings attributed to resources by other users (e.g., references). Resources can be prioritized and graphically differentiated with different identifiers, such as icons, colors, and shapes, for example, based on any category or characteristic, including qualitative variables. Furthermore, the types of interactions/communications contemplated herein enable a user to, e.g., simultaneously interact with more than one resource in order to facilitate an activity or experience that the user desires, e.g., group activities.

It should be noted that for purposes of description herein, a visitor refers to a visiting user that visits the web site of various embodiments, receives certain information, as well as one or more demonstrations and/or advertisements. A member resource refers to a registered, paying member of the website and mobile application that has provided his/her own information and matchmaking/search preferences. With regard to payment, it should be noted that member resources can be required to pay for a membership the website and/or pay for usage of the mobile application as well. A member may list him/herself as a “viewer,” where the user only receives the location of resources without having him/herself displayed to other member users. Additionally, a member may list him/herself as a “resource” where the user and his/her location can be seen in real-time by other members. It should be noted that viewer and resource status may be pre-defined or set on-the-fly.

Additionally, a member resource may schedule availability times and/or foreseen whereabouts. That is, a member resource, for example, can in real-time, or during registration, indicate when and/or where he/she will be available for matchmaking to allow other resources to plan, e.g., an itinerary and/or interaction accordingly. Moreover, a “favorites” list/repository is supported by the matchmaking system/service in accordance with various embodiments. Such a feature enables a member resource to create and store an “address book” or favorites list of the member resource's favorite locations, affiliate resource locations during the day, for example, along with one or more preferred activities/behaviors associated with the favorite locations. Hence and again, because the favorites list is accessible to other member resources that are, e.g., interested in meeting the member resource, the other member resource(s) can plan proposed meetings/times/activities in accordance with the member resource's favorite activities/locations, while minimizing searching for/distance between the resources.

Further still, a member may be later ranked by qualitative attributes of other members per references from former daters, activity partners, etc. A member may also have access to an advanced “Personal Homepage” to mange his/her profile, activities, account, etc. An affiliate resource can refer to a registered and paying establishment, affiliate and/or advertiser. An establishment may bid for advertising on the offered media (website and/or mobile application) and/or for an appearance as a romantic resource that, e.g., sends its real-time location to members. Examples of an affiliate resource can include, but are not limited to other users, hotels, entertainment venues, e.g., nightclubs, flower shops, tennis courts, etc.

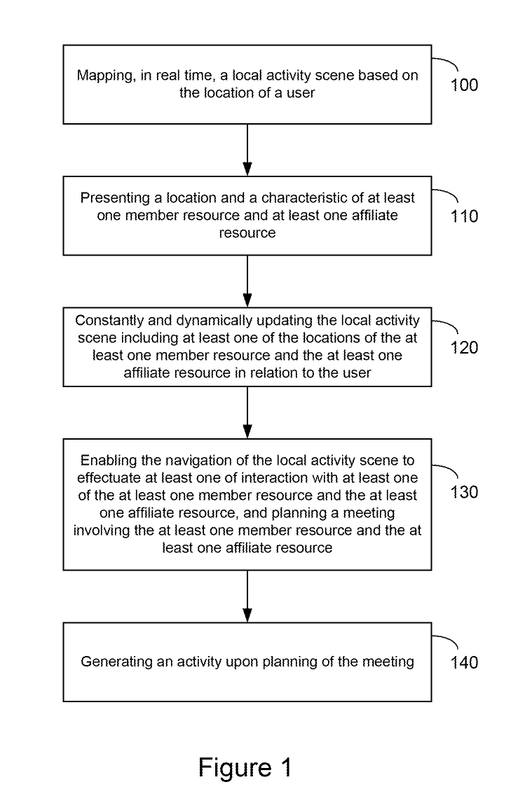

FIG. 1 illustrates processes of a method for mobile mapping performed in accordance with various embodiments. Mapping in real-time, a local activity scene based on a location of a user is performed at step 100. For example, and in accordance with one embodiments, a user utilizes a mobile device and using, e.g., CPS via a cellular network(s) and/or GPS, can observe a local activity scene based on the user's location. At step 110, presenting a location and a characteristic of at least one member resource and at least one affiliate resource is performed. According to one aspect of various embodiments, only the member and affiliate resources that correspond to the user's preferences/requested characteristics appears on a map of the local activity scene. Additionally, the user may invoke a real-time on-demand filter to filter the resources (member and/or affiliate) on the map in a various manners including those that differ from “booked” preferences as described in greater detail below. For example, filtering can be effectuated based on, e.g., a subjective ranking attributed to a member or affiliate resource by other member resources, or by any category that may be relevant at that particular time.

The local activity scene is constantly and dynamically being updated at step 120, including at least one of the location of the at least one member resource and the at least one affiliate resource in relation to the location of the user. Thus the user is able to observe a map that is relevant to the location of the user even if the user is moving. For example, a previously presented affiliate resource may no longer be displayed if the user changes locations and the affiliate resource is no longer within some set or pre-defined local area range. Additionally, the user is able to see the changing locations of other member resources. At 130, navigation of the local activity scene is enabled to effectuate at least one of interaction with at least one of the at least one member resource and the at least one affiliate resource, and planning a meeting involving the at least one member resource and the at least one affiliate resource. That is, as the user wishes to learn more about a particular resource, the user may interactively navigate the map using appropriate controls on the mobile device (e.g., hard keys, soft keys, cursor, etc.) and select or click on an icon representative of the resource. An immediate, real-time description displayed in, e.g., a “balloon” graphic, can be presented to the user informing the user of the member and/or affiliate resource's profile. It should be noted that the profile presented at this stage may be a shortened or “summary” profile as opposed to a resource's complete profile.

From the member and/or affiliate resource's profile, the user may request to automatically initiate some interaction therewith (e.g., via SMS, audio, video, email, etc.) For example, with respect to the affiliate resource, the user may book a reservation/order products/services from the affiliate resource. With respect to the member resource, the user may request contact/interaction with the member resource. Thus, the request can be sent to the member resource and the member resource can approve/deny/postpone/block until a later date/time the contact/interaction. Moreover, the user can request contact/interaction with a group of member resources providing multi-mobile location capability and interaction in accordance with various embodiments. Per the consent of the one or more member resources, for example, the user and the one or more member resources can interact, meet, plan a meeting, etc.

At 140, an activity itinerary can be generated upon the planning of the meeting. That is, the user may issue a real-time proposition for a “complete” meeting, e.g., when to meet, where to meet, the activities to be engaged in, affiliate resources that may enable the engagement in the activities, etc. If the proposition for the meeting is accepted, the user can select, for example, a specified area to meet, the member resource/resources that are to meet, an affiliate resource such as a restaurant or hotel where the meeting can occur, a real time filtering of the above, a day/time of day for the real-time search of available resources/the meeting itself; reserve, e.g., services from the one or more affiliate resources (e.g. a hotel room, restaurant reservations, etc.). It should be noted that the above-described scenario can include more or less itinerary aspects. Moreover, once the itinerary is completed, the user may send the itinerary to the member resource(s) so that the member resource(s) may review the itinerary, express agreement therewith, etc. Thus a complete activity/matchmaking experience can be discovered, planned, and provided by a matchmaking service in accordance with various embodiments.

Interactions and processes that may be implemented in accordance with various embodiments are described in greater detail in a use-case scenario context. In accordance with one embodiment, a user seeks a match with a member resource in his/her local area. To accomplish this use case scenario, the user registers on a website provided by the matchmaking service using, e.g., a personal computer. Payment for membership may not initially be required for only gaining access to, e.g., the real-time maps described above. The user can also register using a mobile device, such as a cellular telephone, where the website can be adapted for mobile device interaction. During registration, the user will enter his/her personal data and also his/her activity/matchmaking preferences (e.g., types of matchmaking facilitators that are preferred, e.g., bars, coffee shops, etc.), and a profile with these preferences are stored in a database. The user downloads and installs a mobile application on his/her mobile device using any one of a plurality of known methods, e.g., a user receiving an SMS message with a download link to the mobile application on the mobile device. As described above, a mobile device capable of working with GPS or CPS and having internet and graphical mapping capabilities is preferred.

Once the application is downloaded and installed, the user may start the mobile application. The user is authorized/authenticated. For example, the user passes authentication information, e.g., name and password, to the application which can verify the user's information. Alternatively, the application can be configured so that upon registration, the user's authentication information can populated into the mobile application by default. Authentication/authorization is performed against a server (e.g., an application server accessible through the Web), by accessing an authentication web service.

When the user opens the mobile application, a map appears with an icon representative of the user displayed thereon in addition to other icons representative of member and/or affiliate resources in the user's local vicinity. It should be noted that prior to the map appearing, advertising may be displayed as described below. As described above, the mobile application can be configured so that other member resources will appear only if those other member resources match the user's characteristics/profile and/or preferences and vice versa. The user may choose one or more resource categories (e.g., member resources, affiliate resources such as bars, flower shops, tennis clubs or courts, etc.) to be displayed or not displayed on the map.

Furthermore, the mobile application reports the user's current (or future) location via GPS/CPS to a server through the web service. The mobile application receives from the server, a list of suitable resources located or currently situated in the local vicinity of the user. The server then utilizes a matchmaking algorithm which will select only suitable resources that match the characteristics/profile and/or preferences of the user. Additionally, the server can rank the matching resources (e.g., better or worse matching) to return only the “top 10” or other number of resources for display on the map if, for example, too many matches would result in a crowded map display.

Furthermore, a feedback mechanism can be configured for the mobile application to allow for ranking resources that will appear on a resource's “details page.” A recommended resource can have, e.g., a different icon (silver, gold, etc.) depending on that resources ranking by other resources. As described above, a user may click or select a resource icon on the map and a balloon graphic with a shortened profile of the resource will appear. To access the resource's complete profile, the user may double click the resource icon, where the mobile application sends one or more additional requests to the server to get the resource's complete profile/details.

The user may request to interact/communicate with a selected resource via, e.g., SMS, voice, vide, etc. by clicking an “interact” button or graphic displayed along with the resource's profile/details. The mobile application will return to its normal mode and will wait for confirmation from the resource with which the user requested interaction/communication with. The communication request can be sent to the resource via SMS for example. The selected resource may then send a confirmation response to allow and proceed with the requested interaction/communication. Once the user receives the confirmation notification from the resource that his/her interaction/communication request has been accepted, the interaction/communication can commence. Various algorithms and mechanisms for prioritizing and/or holding communications or communication requests can be implemented in accordance with various embodiments so that desired interactions/communications will not be missed.

In accordance with another interaction use case scenario, a user receives a communication from another resource that is interested in meeting the user to engage in one or more particular activities. In such a scenario, a user's mobile application is loaded and is currently in active (i.e., map on the screen) or passive (operating in the background) mode. The mobile application periodically reports the user's location to the server through a web service. The user location is received via GPS (built-in or connected to the mobile device) or from a CPS. The user receives a message that can be accompanied by some alerting mechanism such as a vibration or chime. One or more of the requesting resource's details, summary information, etc. is displayed to the user along with the message that the requesting user is interested in interacting/communicating with the user. The message can be, e.g., SMS, voice, video, etc. Any one of a plurality of known communication methods, e.g., SMS with calling party Id, can be utilized to route the message to the user.

If the user wishes to interact/communicate with the requesting resource, the user sends a confirmation response in form of, e.g., a standard or personalized message and an acceptance notification or message will be sent to the requesting resource via, e.g., SMS. The user may review the requesting resource's complete profile/details if the user chooses to do so. If so, the mobile application sends an additional request(s) to the server to get the requesting resource's profile/details. If the user chooses to reject the requesting resource's communication request, a response indicating the rejection will be sent to requesting resource again, via, e.g., SMS.

Additionally, the user can request that particular resources be blocked from sending further interaction/communication requests to the user, and the requesting resource's ID can be added to the user's “black list”. The black list can be stored both locally inside the application/mobile device and reported to the server and stored as a part of the user's profile. Thus, if blocked resource attempts to request an interaction/communication with the user subsequent to being placed on the black list, the mobile application will automatically block the request. Alternatively, any requests from a resource can be blocked after a predetermined number of requests are sent to the user. It should be noted that actual addresses, telephone numbers, or other such identifying information can be kept secret during interactions/communications between a user and a member resource for security purposes. Additionally, interaction/communication fees can be charged to the user and/or a selected resource (member or affiliate).

In accordance with another use case scenario, an affiliate resource may seek exposure to other member resources. For example, an affiliate resource such as a business may wish to appear on maps displayed to member resources. To accomplish this, the affiliate resource would also register on the matchmaking service's website, provide a business profile, location, and contact information. It may be required that the affiliate resource seeking exposure via the mobile application's map pay the provider of the matchmaking service. Information regarding the affiliate resource information is stored in a database that may be remotely or co-located with the server described above. The affiliate resource may also provide additional information, such as targeting data, e.g., a type of member resource that is a target consumer for the affiliate resource's own services, products, etc.

Once the affiliate resource is registered with the matchmaking service, member resources accessing the application on a mobile device or via the website will see an icon representing the affiliate resource on a map presented to the user if the affiliate resource is in the user's local vicinity. Each type of affiliate resource may be displayed using a representative icon. For example, an affiliate resource that is a bar may be represented on the map by a beer glass icon, while an affiliate resource that is a cafe may be represented by a coffee mug, and so on. Additionally, an affiliate resource's information will be received from the server together with, e.g., the identity, profile, icon of other member resources in the user's local vicinity so that the user is aware of its presence on the map. Again, it should be noted that affiliate resources can include member resources that, e.g., provide certain services or products, in addition to businesses and the like. As is done with member resources, users will be able to click an affiliate resource's icon to see a detail summary/shortened profile regarding the affiliate resource. Users will also be able to click the icon again/double click the icon to see the full profile of the affiliate resource.

Every time a detail summary and/or full profile of the affiliate resource is accessed by a user, an instance of this exposure will be reported to the server for statistics and/or billing purposes. Alternatively, an instance of exposure can be reported to the server every first or second instance, where the reporting can be effectuated immediately or gathered on the application/mobile device and then reported to the server periodically. As is also done with member resources, a user is able to filter affiliate resources per category, sub-category, rating, etc., where resources can rank or leave feedback regarding the affiliate resource, and the affiliate resource can be identified on a map with a commensurate icon, e.g., a gold beer glass for a “top-rated” affiliate resource that is a bar.

Unique revenue opportunities for the matchmaking service provider can be explored as well. For example, and as described above, advertiser affiliate resources can be required to pay for one or more advertisements on a per-exposure instance basis. Additionally, advertiser affiliate resources can bid for advertising space on either the website and/or on the mobile application. Further still, advertiser affiliate resources can pay graduated fees, where the size and/or location of an advertisement or banner can cost more or less. Targeted advertising space, location-based advertisements, and/or profile-based advertisements described in greater detail below can be sold or auctioned for a larger fee than general advertisements.

In accordance with yet another use case scenario, a business or third party service/goods provider wishing to advertise on the application will access a Banner Management System (BMS), such as those provided by a third party BMS service provider. A BMS can be deployed and configured to support the advertising aspect(s) of the matchmaking system and application. Affiliate resources using the BMS will manage advertising campaigns and upload banners to the BMS, which will be able to provide advertisement expiration conditions and specify a target audience(s) according to the affiliate resource's target information and member resources' profile and/or preference information. Additionally, the BMS will be customized to match those member resource profiles/preferences. Thus, upon executing the application, member users see, e.g., advertisements and/or banners on the login screen, on a splash screen before a map is loaded, or at predetermined/random times during the use of the application. The application downloads one or more advertisement from a BMS server when the application is, e.g., in a background mode and store it locally for presentation at a later time. Alternatively, the application can access the BMS server at the time an advertisement or banner is to be displayed to a user.

User's accessing the mobile application via a mobile device can, e.g., click on the advertisement or banner and be re-directed to a corresponding mobile website associated with the affiliate resource in a local mobile web browser that is opened. User's accessing the application website or website visitors see the advertisements and/or banners on website pages and are able to click on an advertisement or banner to see a linked web page to, e.g., a website of the affiliate resource. For billing and statistics, each advertisement or banner click (or over some predetermined number of access instances) will be reported to the BMS server which has its own web service for storing and processing these reports. Affiliate resource advertisers can access or will receive detailed and statistical reports about their advertising impact, banner clicks, etc. in the BMS according to capabilities of the BMS, e.g., charts, tables, matrices, etc. Additionally, the matchmaking service/application manager may also see advertiser affiliate resources' statistics (which may be used for future billing, statistics reporting, etc.), by logging into the BMS, for example.

A description of an exemplary architecture of a matchmaking system with which various embodiments of the matchmaking service can be implemented is as follows. The system consists of a client side (e.g., mobile application, Java J2ME or .NET Mobile for Windows CE/.NET Compact Framework) and a server side (e.g., Java or ASP.NET web application). It should be noted that the above implementations are exemplary and other appropriate applications and/or platforms may be utilized in accordance with various embodiments.

The server side includes a website with a registration and profile update utility for member and affiliate resources. Additionally, the server side contains a “back office” for user management, data management, reporting and statistics, etc. and an advertisement management system providing targeted advertisement (e.g., targeting based on a member resource profile, age, occupation, categories of interest, gender, etc.). Also associated with the server side is a database for storing and accessing information about the member and affiliate resources. For member resources, the database contains a personal profile and preferences, e.g., romantic preferences. For affiliate resources, the database contains a business profile and preferences (e.g., certain establishments may have an age preference of over 21 and an icon representative of such an affiliate resource will appear on the map of suitable member resources only).

Further still, the server side has web services for performing at least the following functions: authenticate a mobile application user/member resource by user name, password, and/or device ID, etc.); receive periodical reports of a user's location relative to other member resources; provide a list of member resources and affiliate resources located around a specific user (e.g., a list of resources with their details and coordinates)—with a “gradual parameter zone.” That is, if a user cannot find an appropriate resource within some distance range parameter, e.g., a 250 meter radius, the server will enlarge the parameter zone to enable the inclusion of appropriate resources that are further than the initial distance range; and provide a list of member resources according to a user search conditions/preferences.

From a client perspective, the client side contains a mobile platform-based application which has the following features: user authentication; providing advertisements and/or banners; display of a map with user location and other relevant resources in the user's local vicinity; ability to allow a user to click selected resources on the map; review the resource's data (shortened summary or detailed as described above); request interaction/communication with the selected resource by, e.g., SMS, voice call; voice and video call, etc.; and manage (accept/reject/block) another member resource's requests for interaction/communication.

Furthermore, the client side can utilize a third party Geographic Information System (GIS) service for its map functionality. That is, the client side will receive maps from this GIS service through its web services and display it using a GIS service software development kit (SDK). Additionally, the client side may cache maps locally for better performance. In addition to map display, the client side also enables displaying of the clickable/selectable resource icons on the map.

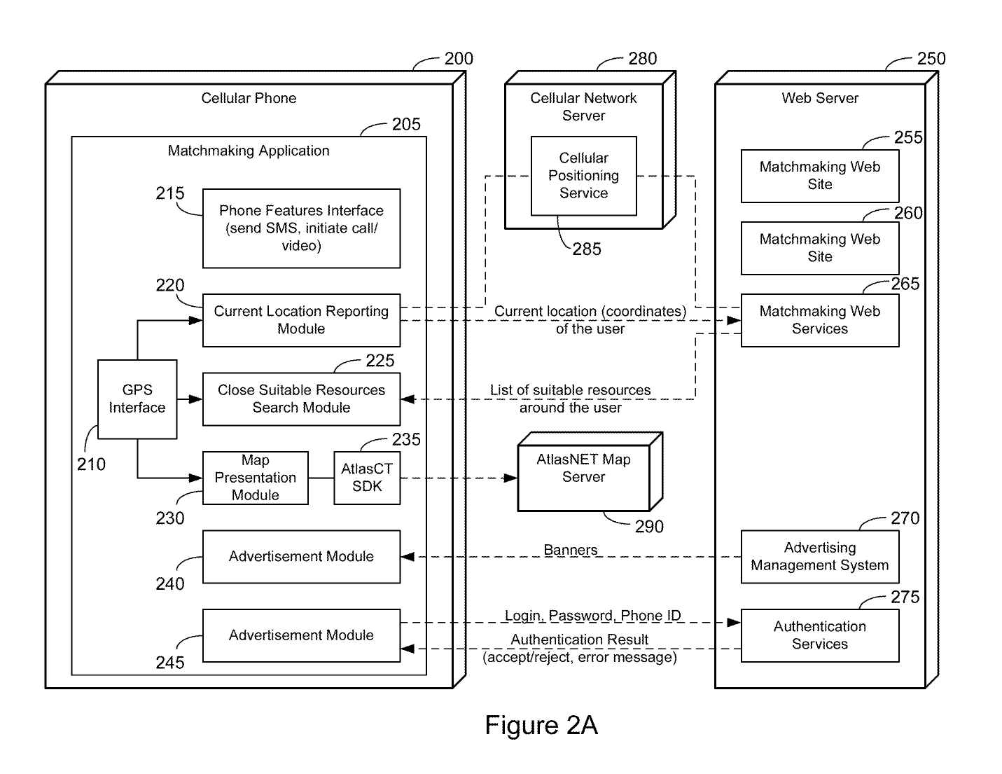

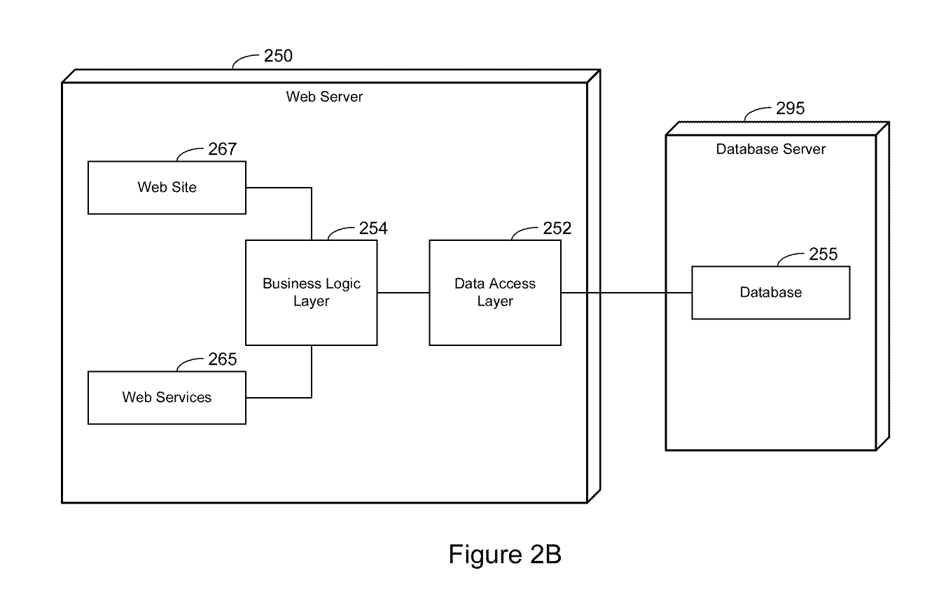

FIG. 2a illustrates a component model overview of exemplary components with which various embodiments are implemented. A cellular phone 200 interacts with a web server 250 and a map server 285 (e.g., an AtlasNET map server), where the cellular phone 200 communicates with the web server 250 via a cellular network server 280 as described above. The cellular phone includes a matchmaking application 205 which includes a GPS interface 210, a phone features interface 215, a current location reporting module 220, a close suitable resources search module 225, a map presentation module 230, a map server SDK 235, an advertisement module 240, and an authentication module 245.

The GPS interface 210 communicates, e.g., location information to the current location reporting module 220, the close suitable resources search module 225, and the map presentation module 230. That is, the current location reporting module 220 receives a user's current location coordinates from the GPS interface 210 and reports it to the matchmaking web services module 265 of the web server 250 periodically, e.g., every “x” number of minutes. If a previous reported location has not changed, e.g., the user is not moving, there is no need to report to the matchmaking web services module 265. Alternatively, the current location reporting module 220 can receive location information from the cellular positioning service 285 of the cellular network server 280, which also reports to the matchmaking web services module 265.

The close suitable resources search module 225 also receives a current user location from the GPS Interface 210 and requests identification of suitable resources from the matchmaking web services module 265. If suitable resources are available, the matchmaking web services module 265 returns a list of one or more suitable resources that match the user's profile, search preferences, etc. along with details and coordinates of the one or more resources.

The map presentation module 230 displays a map based on the user's current location and receives from the close suitable resources search module 225, a list of suitable resources and displays their icons on the map to be presented to the user on, e.g., a display of the cellular phone 200. As described above, the map presentation module 230 may interact with the map server (e.g., AtlasCT) SDK 235 which accesses relevant maps from the map server 290.

The advertisement module 240 receives advertisements/banners from the advertisement management system 270 of the web server 250 and displays the advertisements/banners as described above. The authentication module 245 of the cellular phone 200 interacts with the authentication services module 275 of the web server 250 to exchange, e.g., a user's login and password information, as well as exchange authentication accept/reject/error messages.

The matchmaking website module 255 implemented on the web server 250 allows for website that member resources and affiliate resources can register over, and where these resources can provide a profile and preferences. The matchmaking web services module 265 as described above, performs various processes including, e.g., receiving a user's current location, responding with a list of suitable resources according to a user's location, profile, and/or preferences. The advertisement management system module 270 allows multiple advertisers, e.g., business/service/goods provider affiliate resources to upload their advertisements and/or banners. Additionally these affiliate resources may configure targeted advertising rules and receive reports through the advertisement management system 270.

FIG. 2b is an exemplary server side component model diagram for implementing various embodiments. As described above, the matchmaking service can include a web service and web application in the form of, e.g., a website that resources may access and interact with. FIG. 2 illustrates a layered architecture that allows for future flexibility in implementing the matchmaking system as well as for future scalability. As described above, one embodiment may be implemented as a multi-layer ASP.NET application that is connected to an MS SQL Server 2005 database. The web server 250 includes a data access layer 252 that is built of strong-typed data sets and data adapters. The web server 250 also includes a business logic layer that contains, e.g., business affiliate resources/entities, business entities managers (logic), and different infrastructure classes (e.g., exception handling, event logging, etc.) The web services module 265 can be implemented as an ASP.NET web application with web services, and will contain web pages, forms authentication, web services, and different infrastructure classes (exception handling, event logging etc.). The actual web site 267 can be implemented as an ASP.NET website.

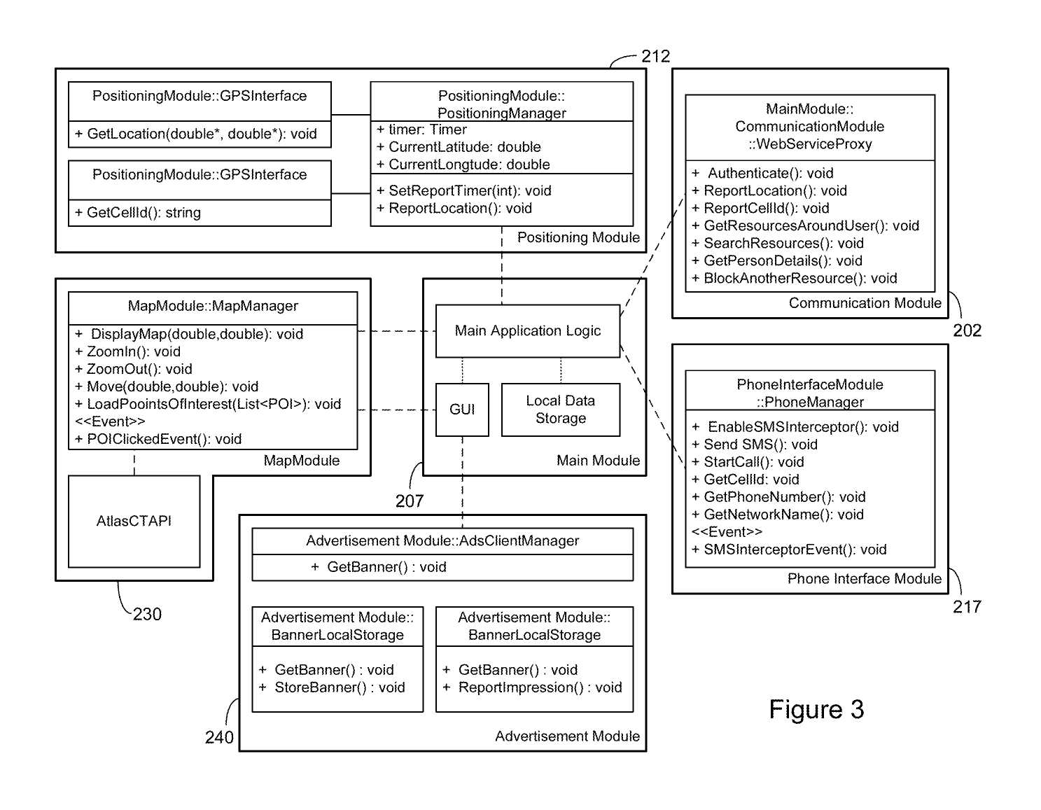

FIG. 3 illustrates the client side (e.g., cellular phone 200) component modules in greater detail along with representative classes and syntax. The cellular phone 200 includes a communication module 202 that is responsible for communication with the web server 250. The communication module may initially contain web service proxy classes, encryption mechanisms, etc. Additionally, it should be noted that hypertext transfer protocol (HTTP) requests can be utilized to reduce traffic. The cellular phone 200 also includes a main module 207 that comprises at least main application logic, a graphical user interface (GUI), and a local data storage for storing, e.g., a user's black list, and a cache of recently receive resource details. The GPS interface module 210 includes a positioning module that obtains and reports the user's location to the web server 250 and to the matchmaking application itself.

The phone features interface 215 includes a phone interface module for accessing and executing phone functions, e.g., sending SMS messages, initiating, receiving, and terminating phone calls, etc. The map presentation module 230 contains a map module 232 that is responsible for retrieving a current map from a map server application programming interface (API) and displaying it on the screen of the cellular phone 200. Additionally, the map module 232 loads, e.g., points of interest (POIs) to the map and may be configured to expose certain events, e.g., when a user clicks on a POI icon. The advertisement module 240, as described above receives advertisements/banners from the BMS server and displays the advertisements/banners on the screen of the cellular phone 200 during, e.g., login, application startup, etc.

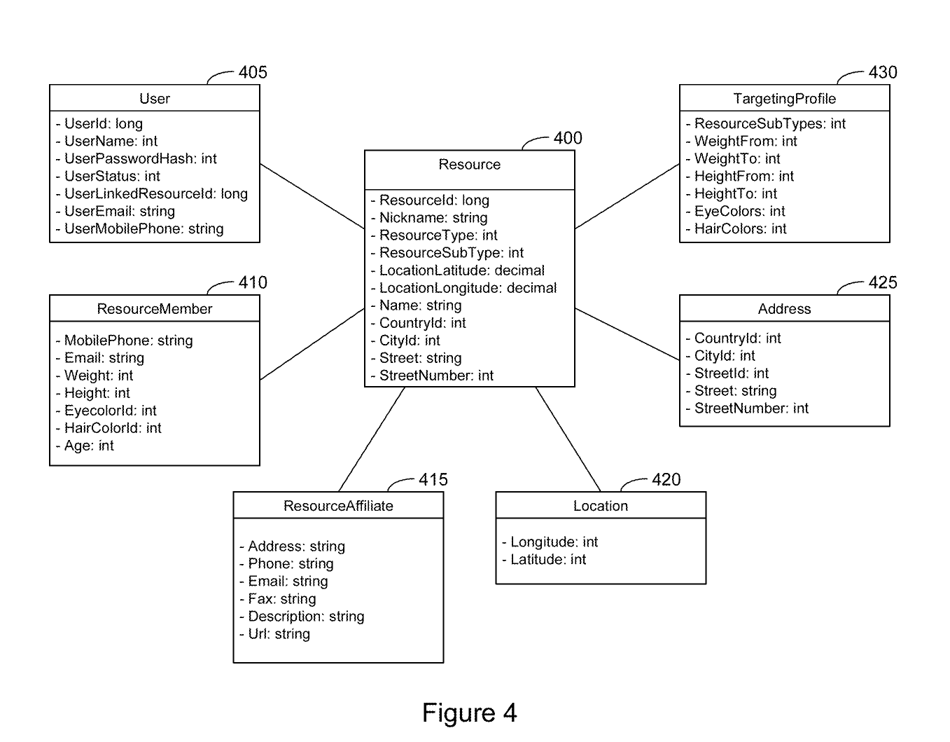

FIG. 4 illustrates various domain model objects of various entities of the matchmaking system in an exemplary domain model overview in accordance with various embodiments. A resource object 400 is shown in FIG. 4, where the resource object 400 is defined by elements, such as a resourceID represented by a long integer, a nickname represented by, e.g., a character string, an integer resource type, etc. As described above, a resource may be a member resource represented by a ResourceMember object 410 defined by its own elements, e.g., mobile phone, email, weight, height, etc. A resource may also be an affiliate resource, such as a business, where the ResourceBusiness object 415 is defined by elements, such as an address, a phone number, an email, etc. A User object 405 is defined by elements, such as a UserID, a Usemame, a UserPasswordHash, etc. Moreover, a Location object 420 including, e.g., longitude and latitude value elements, and an Address object 425 including, e.g., a CountryId, a CityId, etc., are associated with the Resource object 400. Further still, a TargetingProfile object 430 can be associated with the Resource object 400 including, a ResourceSubTypes element, Weightfrom and Weighto elements, etc.

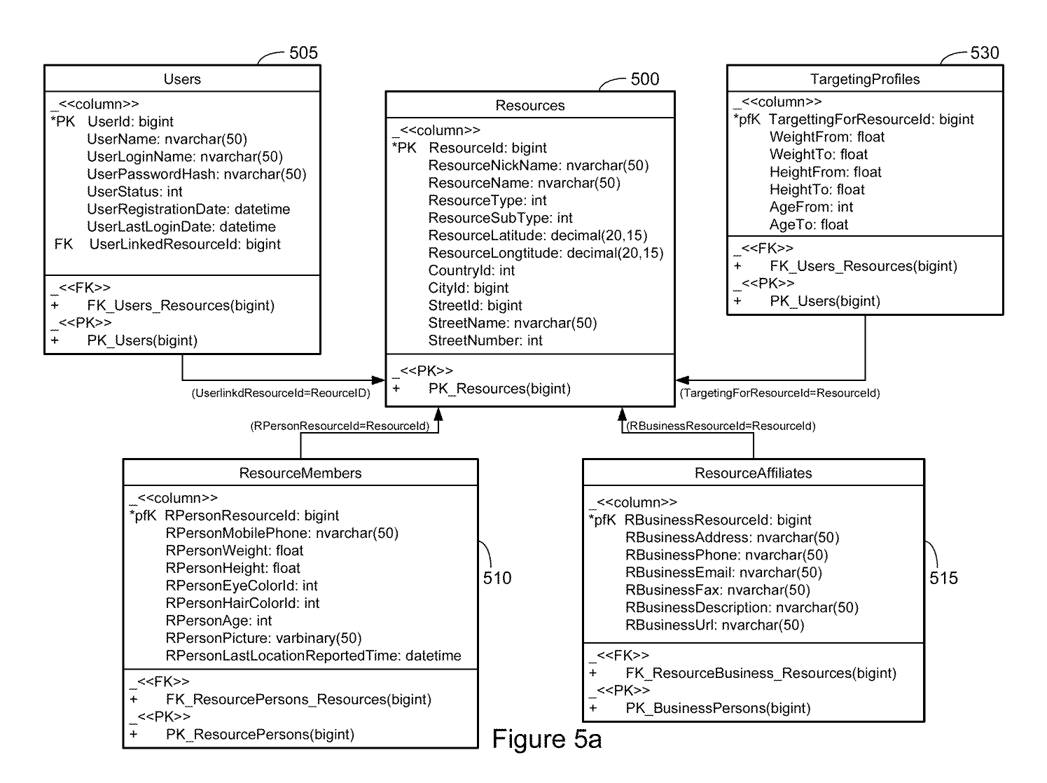

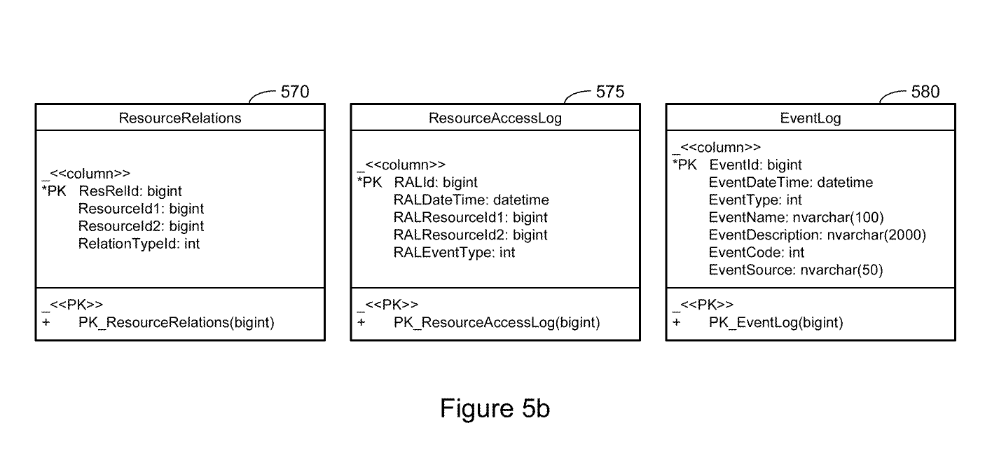

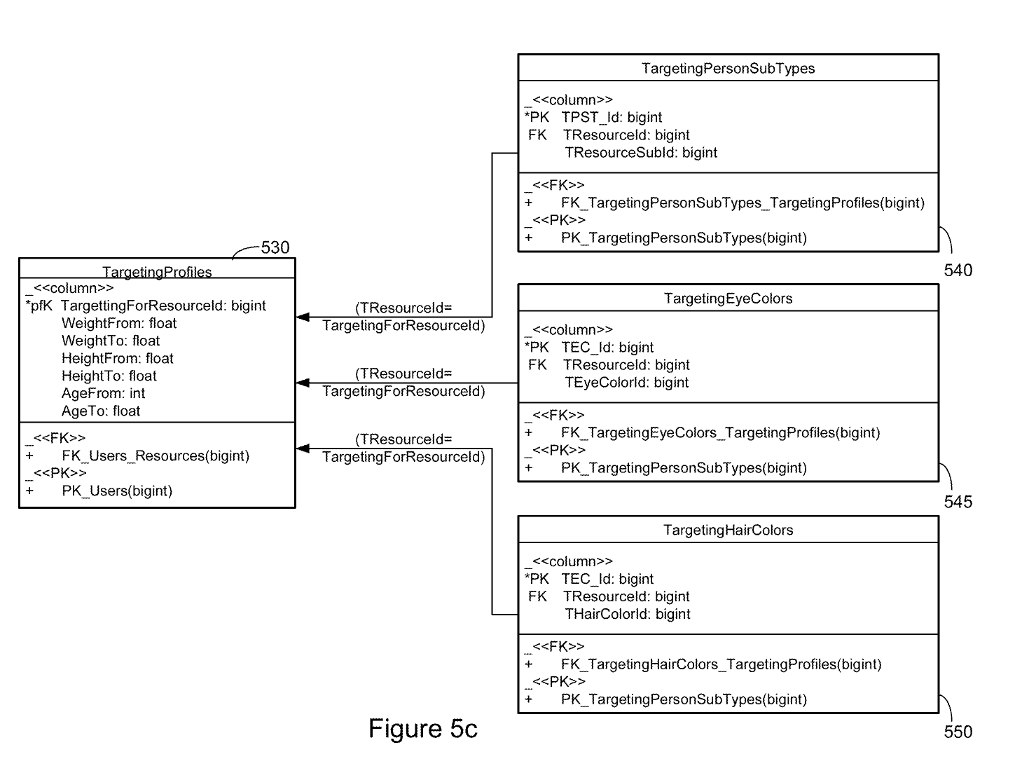

FIG. 5a illustrates a data model for implementing various embodiments indicative of how entities will be stored in respective tables. All resources may be stored in a Resource table 500, and all users are registered in a User table 505, where each user has one associated resource. For example and as described above, a user will be a member resource. ResourceMembers table 510 and ResourceAffiliates table 515 are utilized to store, e.g., person/member resource-specific resource data and business/affiliate resource-specific resource data, respectively. Additionally, resource targeting preferences (e.g., parameters of a desired target audience who will see a particular resource on a map) are stored in a TargetingProfiles table 530. Selected targeting properties for, e.g., “multi-selection” features, such as a suitable member resource type (man or woman), eye color, hair color, interests, etc. can be stored in TargetingPersonSubTypes, TargetingEyeColor, TargetingHairColor tables 540, 545, and 550, respectively. It should be noted that more or less tables may used to store relevant data.

FIG. 5b illustrates additional tables that may be utilized to store resources relations and logs in accordance with various embodiments. For example, a ResourceRelations table 570 may be used to store relationship information indicative of a relationship between, e.g., two resources. Relation types can be, e.g., “1-block,” where resource 1 may not allow resource 2 to see him/her or contact him/her, and “2-block,” where resource 1 always allows resource 2 to see and/or contact him/her without the need for confirmation. It should be noted that various embodiments described herein contemplate other relation types. A ResourceAccessLog 575 refers to an event log for resources. The ResourceAccessLog 575 registers each login to the matchmaking website or mobile application and/or other actions such as a member resource selecting an affiliate resource via the map, etc. For example, event type 1 can refer to a registration instance, event type 2 can refer to a login instance, and event type 3 can refer to selection of another resource, etc. An EventLog 580 can be utilized to record different events that require administrative attention, e.g., exceptions, logical errors, data inconsistencies, etc. It should be further noted that the data base may also store different libraries referenced in the tables described above.

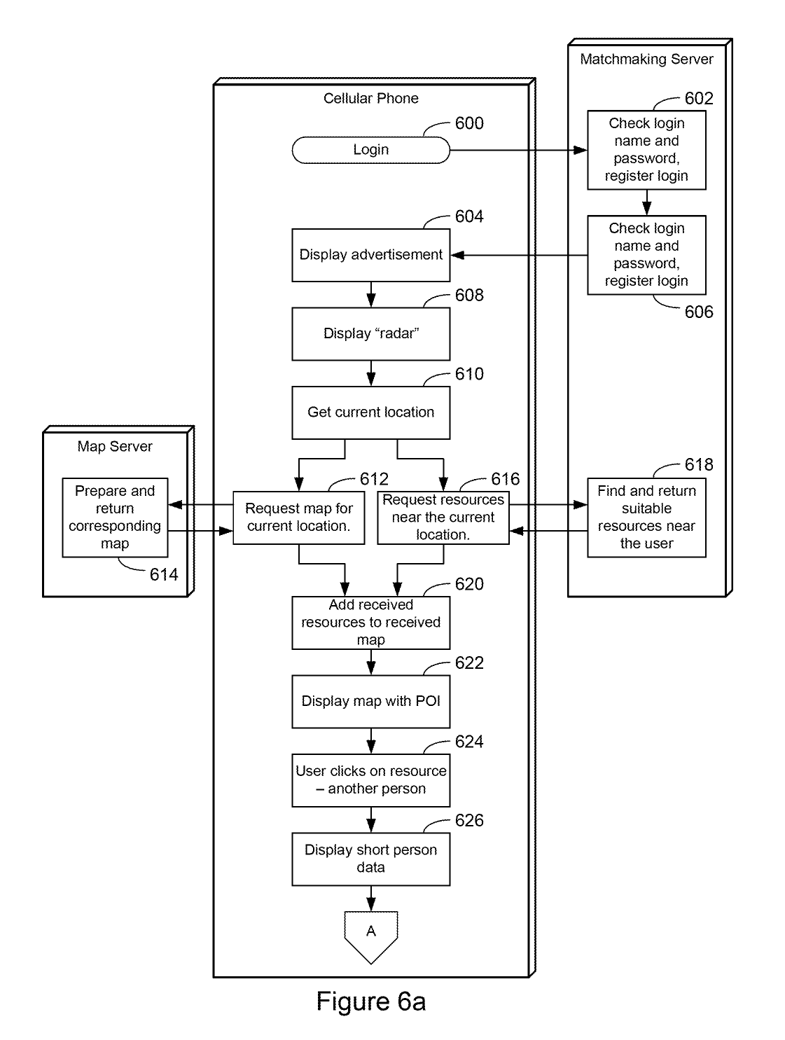

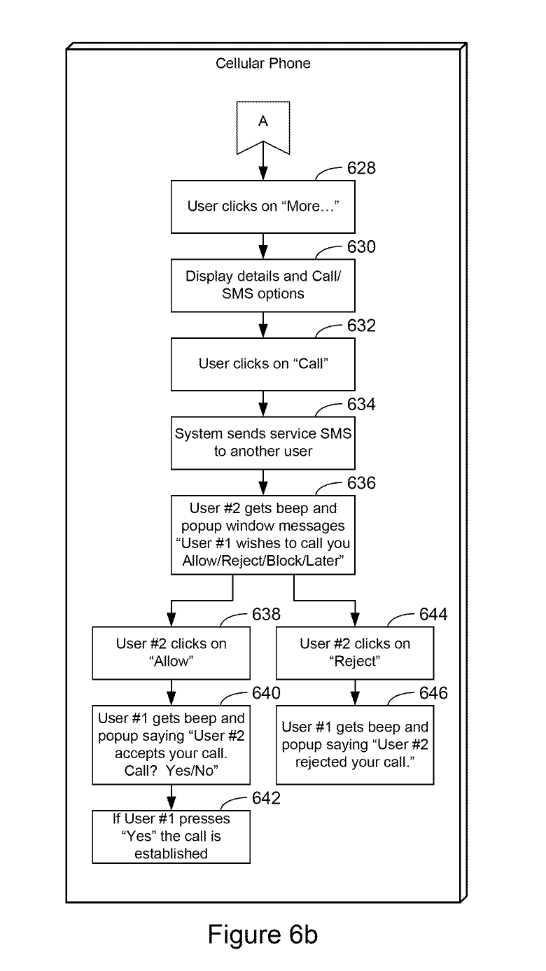

FIG. 6 is a more detailed flow chart illustrating processes performed in accordance with various embodiments in conjunction with the matchmaking system elements in which the various processes are performed. At step 600, a user logs into the matchmaking application using his/her cellular phone, whereupon at step 602, the matchmaking server checks the user's login name, password, or other relevant information and registers the login event. At step 604, an advertisement can be displayed to the user on the cellular phone and at step 606, the matchmaking server can return a status indicating either a successful or failed login.

Upon a successful login, the cellular phone displays a “radar” graphic at step 608 while a current location for the user is retrieved at step 610. A map server is accessed at step 612 and a map is requested for the user's location. The map server then prepares and returns a corresponding map to the cellular phone at step 614. The cellular phone requests resources near the user's current location at step 616 via the matchmaking server, and at step 618, the matchmaking server finds and returns suitable resources near the user's location.

At step 620, a map is populated with the received resources. Additionally, the application on the cellular phone can populate the map with POIs at step 622. If the user is interested in a particular resource, either a member resource or an affiliate resource, the user can click/select the desired resource at step 624. For example, if the selected resource is a member resource/person, the selected member resource's shortened details are displayed at step 626. If the user double-clicks or selects an option to see “more” details regarding the selected member resource at step 628, more details, e.g., the complete profile data of the selected member resource is displayed to the user at step 630. Additionally, interaction/connection options are presented to the user. If the user chooses to contact the member resource, at step 632, the user clicks on, e.g., a call button or icon. At step 634, the cellular phone sends a service SMS to the selected member resource either directly to a device used by the selected member resource or via the matchmaking server.

At step 636, the selected member resource receives a message and, e.g., a popup window appears on the selected member resource's own cellular phone or other mobile device indicating that the user wishes to interact. Moreover, the selected member resource is given the option to either allow, reject, block, or respond to the interaction request at a later time, for example. If the selected member resource chooses to interact with the user, at step 638, the selected resource may indicate the allowance of the interaction. At step 640, the user receives a response indicating that the interaction request has been accepted by the selected member resource and an option to call, SMS, email, etc. the selected member resource is presented to the user. If the user chooses to contact the selected resource at that time, the user indicates this choice by, e.g., pressing “1” and the call/connection is established at step 642. If the user's request is rejected, the user receives a response indicating the rejection by the selected member resource at step 646.

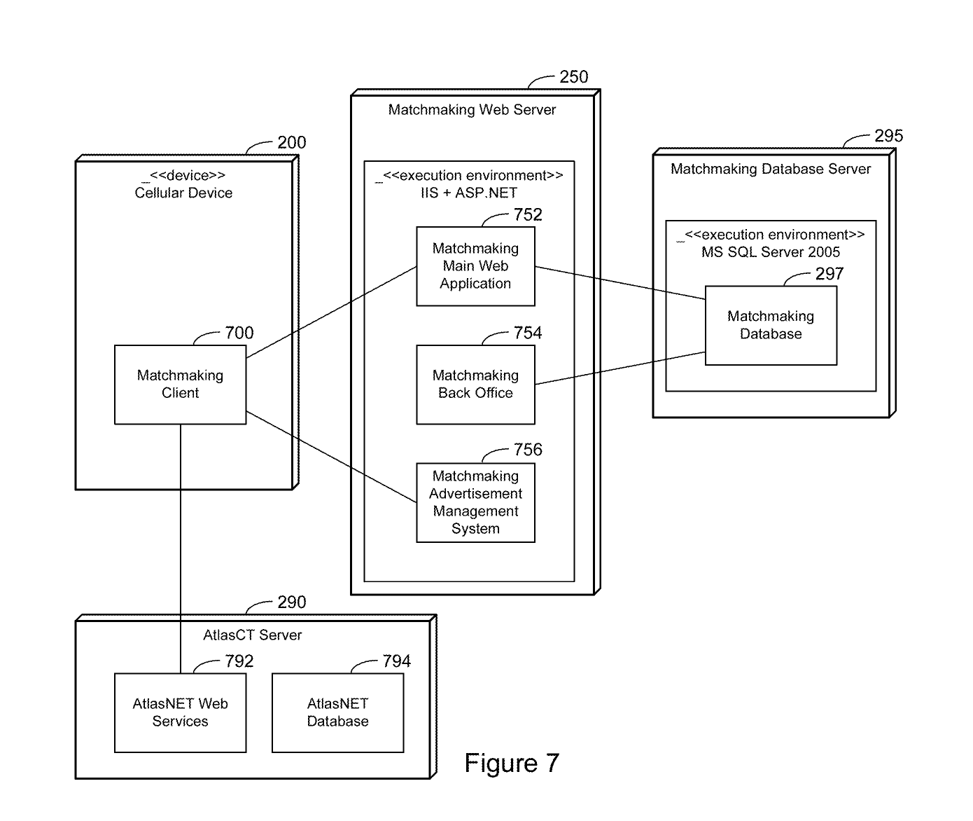

FIG. 7 is an overview diagram of the matchmaking system modules architecture in accordance with various embodiments. As described above, the matchmaking system may include, e.g., a cellular phone 200, a matchmaking web server 250, a matchmaking database server 295, and a map server (e.g., AtlasCT server) 290. From a system module perspective, the “main” system modules include a server-side main system, a server-side advertisement management system, a server-side back office, and a client-side mobile-based application.

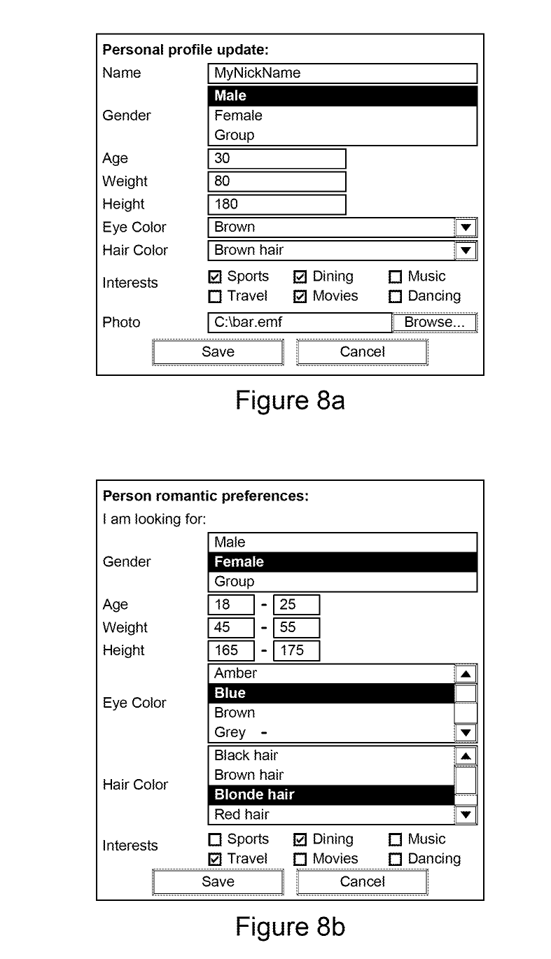

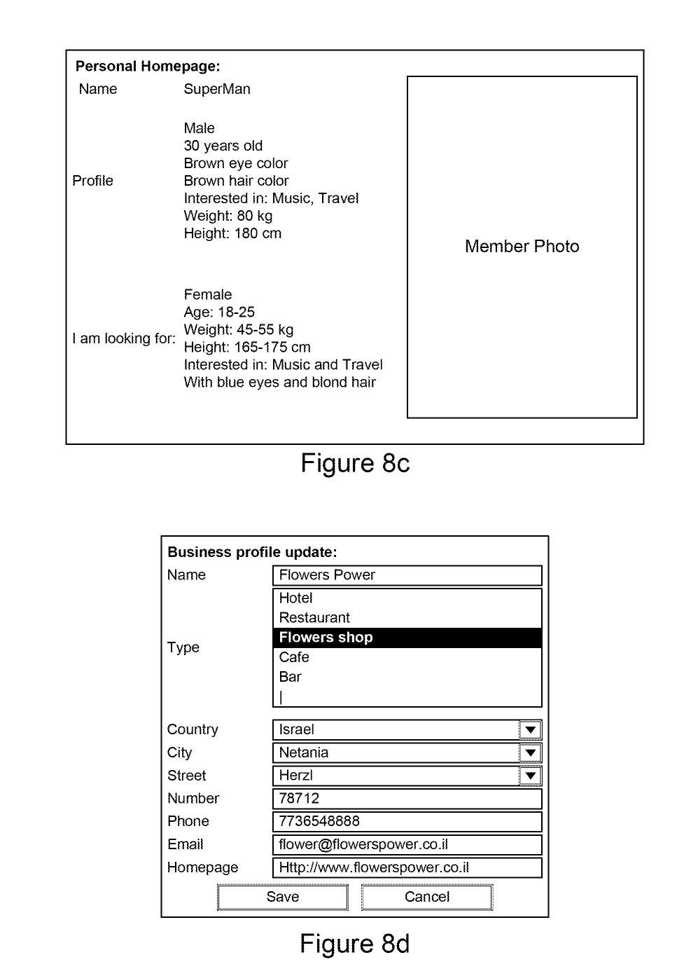

The server-side main system includes a matchmaking main web application 752 that provides a user GUI (e.g., website) for user registration/profile management and data exchange interfaces (e.g., web services) for the mobile matchmaking application. The server-side user interface is the web application 752, that a user accesses through a web browser. When a user registers on the web site, he/she provides a personal profile, romantic preferences, and other relevant information and becomes a member resource. FIGS. 8a and 8b are exemplary illustrations of a GUI with which a user enters his/her personal profile and romantic preferences. FIG. 8c is an exemplary illustration of a web homepage that can be created for a user upon registration with the website. When a business registers on the web site, as described above, the business provides, e.g., a business profile, targeting data, etc., and becomes an affiliate resource. FIG. 8d is an illustration of an exemplary GUI with which business affiliate resource may update its profile.

The server-side matchmaking back office 754 provides various functionality in the matchmaking system. For example, the server-side back office provides a browse event log as well as user management, e.g., enabling and/or disabling a user's access to the matchmaking system (e.g., mobile matchmaking application and web site). Additionally, the server-side matchmaking back office 754 handles business affiliate resources management, again, e.g., enabling/disabling access, deleting an affiliate resource from the matchmaking system, etc. Further still, the server-side matchmaking back office 754 maintains various types of libraries, such as business types, eye color, hair color, settings, etc., as well as performs statistical reporting, e.g., logins, affiliate resource exposure instances, etc.

The server-side matchmaking advertisement system 756 allows advertisers to place their advertisement(s)/banner(s) on application screens (, e.g., the matchmaking web site and mobile-based application). As described above, a BMS may be utilized to implement the server-side advertisement system. A BMS may have various features including, but not limited to the following: multiple banner types (e.g., Flash, Html, GIF, JPG, BMP, Text); advertising campaigns management; flexible audience targeting (fully adjustable to any user/targeting profiles with any list of features , e.g., age, categories of interest, eye color, etc.); intelligent suitable banner selection algorithm for each member resource; an intuitive and simple interface; automatic information retrieval (via, e.g., ip2country, for retrieving country-specific information from an IP address/number group); dashboard; and various advertising-related reports, charts, etc.

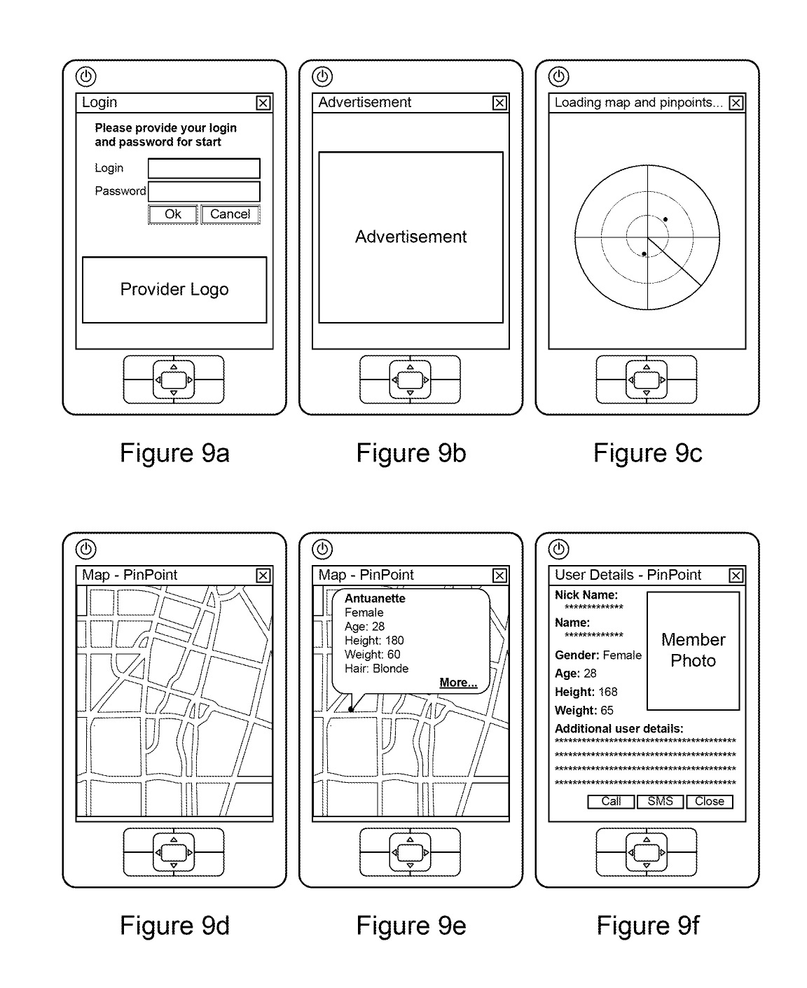

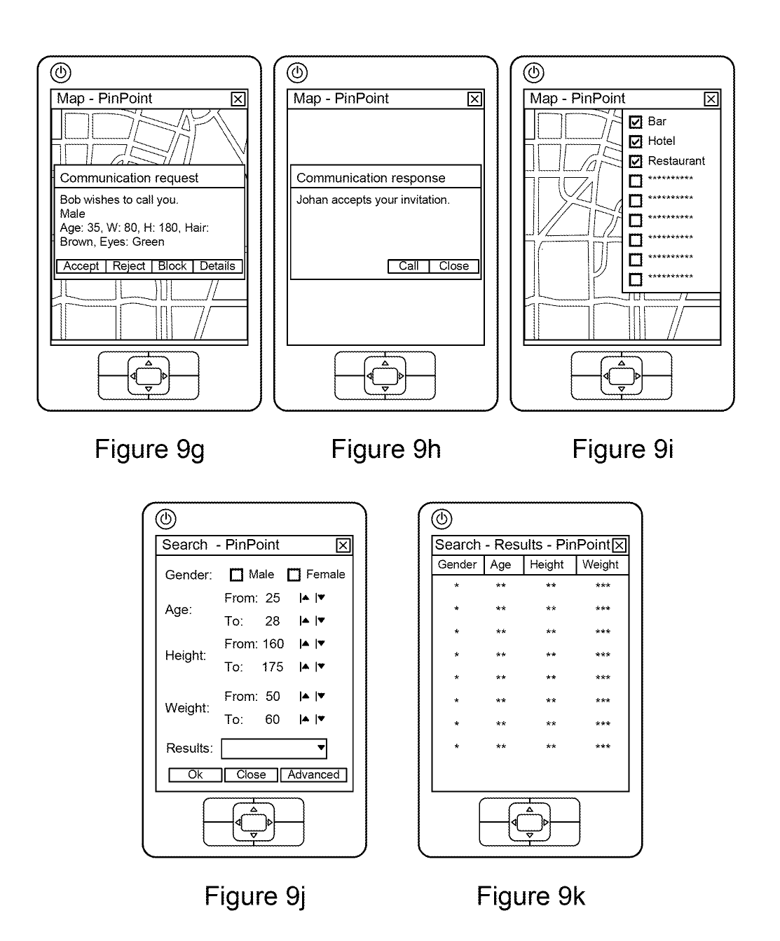

The client-side application/matchmaking client 700 is the mobile matchmaking application, which can be based on, e.g., a .NET Compact Framework 3.5 for Windows Mobile 6.0. The application uses an AtlasCT Mobile SDK to display maps and an AtlasNET server as a map server/source. As noted above, various embodiments may be implemented using various applications and/or platforms and are not limited to the implementations described herein. FIGS. 9a-9k illustrate various exemplary maps, screens, GUIs, and interfaces that the client-side application may display on user's cellular phone or other mobile device. FIG. 9a is an exemplary login screen, FIG. 9b shows an exemplary advertisement that can be shown during the authentication process, and FIG. 9c illustrates a “radar” graphic that may be displayed to the user while an appropriate map is being searched for, downloaded, etc.

FIG. 9d is an example of a map of a user's current location, while FIG. 9e is an example illustrating a short/summary data display to the user when the user first selects a resource on the map by, e.g., clicking on the resource icon. FIG. 9f is an example of the selected resource's “complete” profile/information which is displayed to the user if the user clicks on the “more” option illustrated in FIG. 9d or double-clicks on the resource icon. FIG. 9g is an example message displayed on the selected resources' mobile device indicating that the user wishes to interact with the selected resource as well as, e.g., shortened/summary details of the user. FIG. 9h illustrates an exemplary message display that can be displayed to the user upon the selected resource's acceptance of the user's request to interact/communicate.

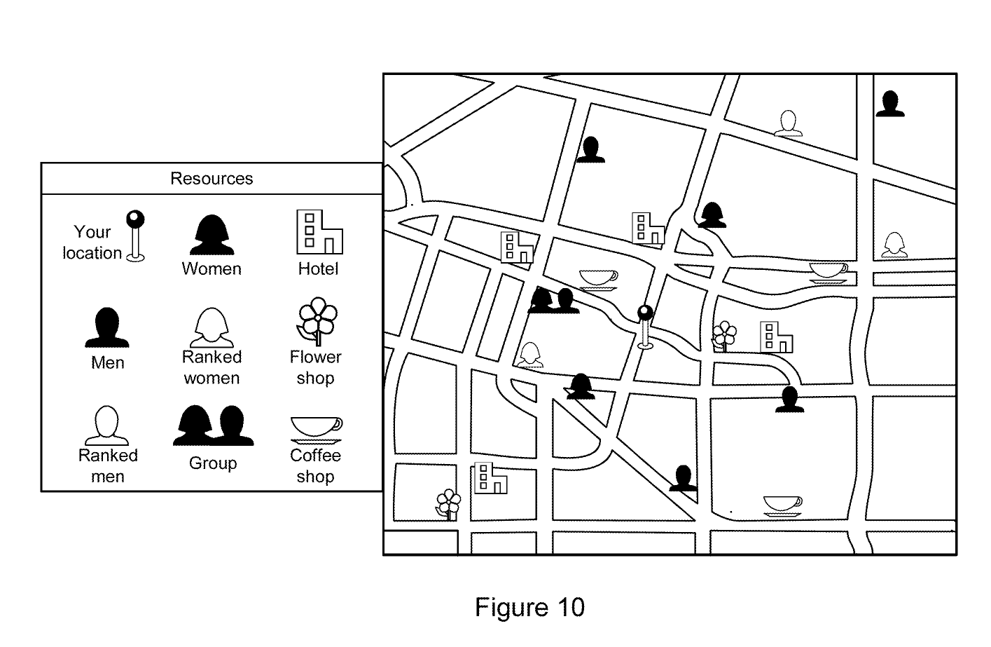

FIG. 9i is an example of a GUI display that allows to user to enter his/her search preferences for affiliate resources in his/her local vicinity. FIG. 9j is an example of GUI display that allows the user to tailor a search for a member resource, and FIG. 9k is an example of the user's search results. FIG. 10 is an example GUI display of various types of resource icons and a map populated with relevant resource icons in a user's local vicinity, where as described above, different colors and shapes may be utilized to identify different types of resources, resources of differing rank or rating, etc. It should be noted that other types of distinguishing identifiers, such as pictures, icons, characters, coloring, etc. can be utilized to identify resources in accordance with various embodiments.

Moreover and as described above, location information, maps, etc. can be received and/or created via the map server 290, which includes web services 792 and a database 794. The matchmaking web server 250 also accesses its own matchmaking database server 295 with its matchmaking database 297. It should be noted that the cellular device/phone 200, the matchmaking web server 250, and the map server 290 can interact and communicate with each other over data networks, such as the Internet.

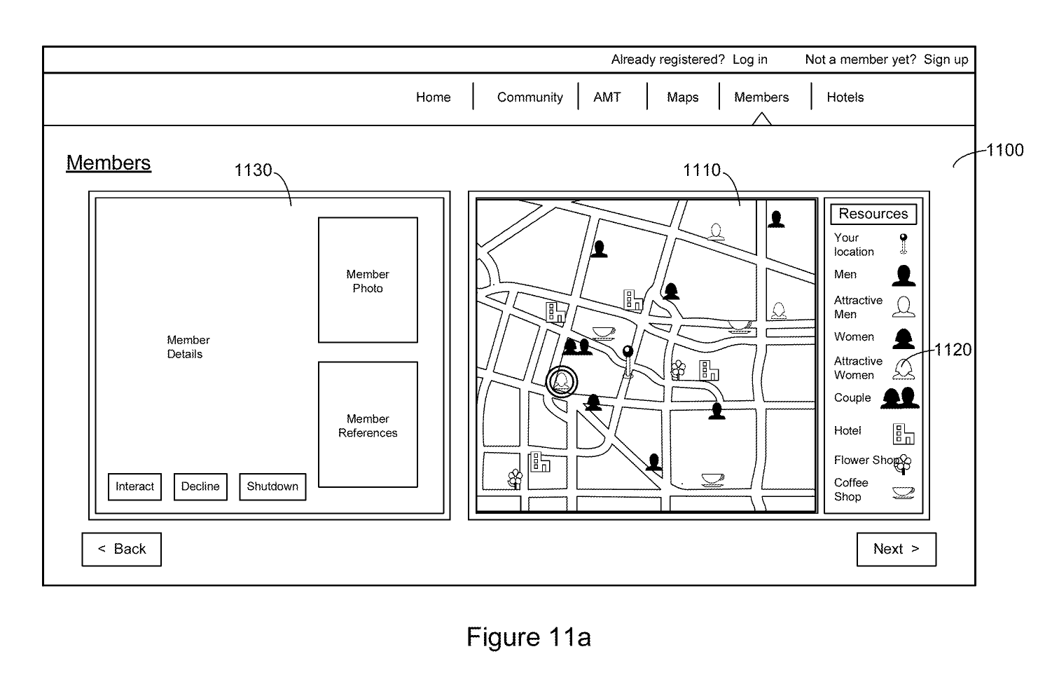

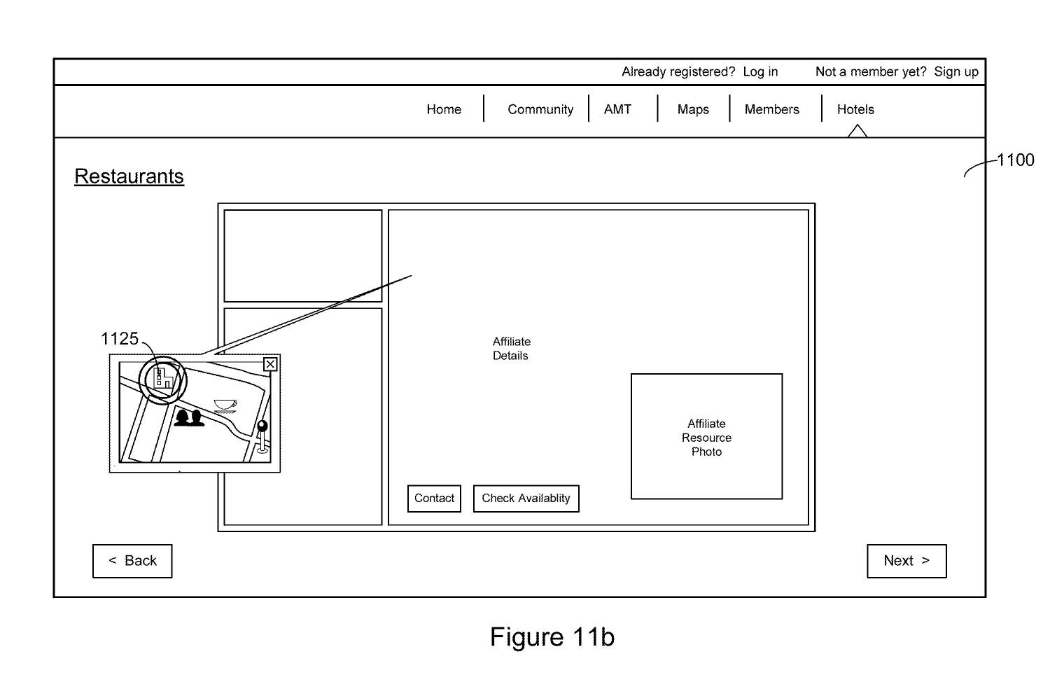

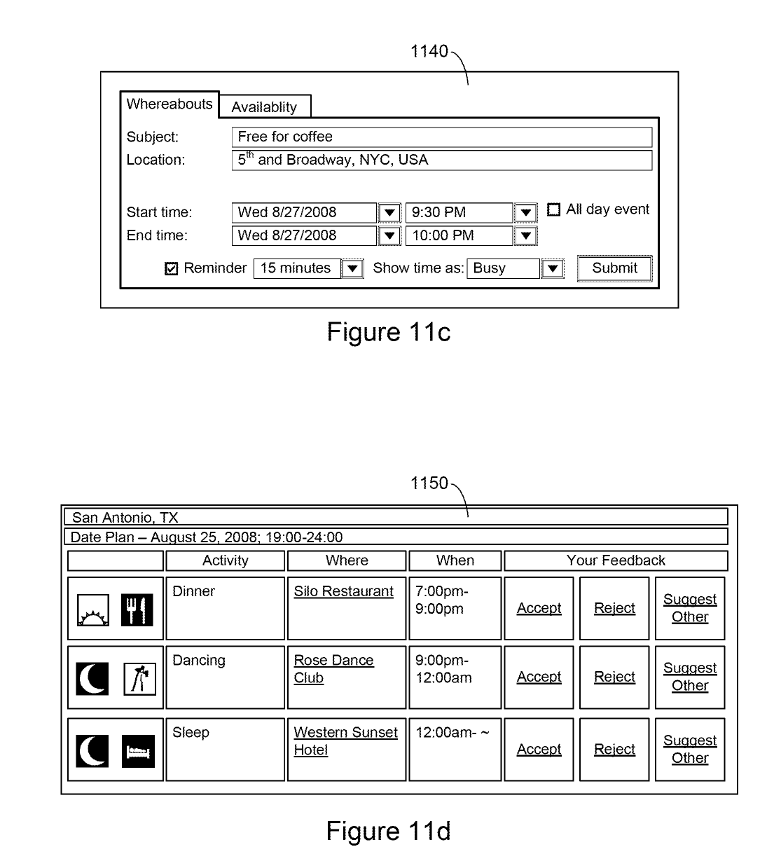

As described above, although various embodiments provide real-time and dynamic mapping of romantic resources according to, e.g., a user's current location, various embodiments also allow a user to survey the activity/romantic “scene” and/or create one or more romantic itineraries for future travel in advance. FIG. 11 is an exemplary webpage displaying a map of a location that the user will be at, e.g., in the future. For the example the can be located in city A, where he/she has accessed the matchmaking website 1100. The matchmaking website 1100 can be directed to display a map 1110 of city B where the user will be traveling to. The map 1110 of city B can be continuously and dynamically updated in real-time so that the user is experiencing the activityc “scene” in city B as it is occurring.

As with various embodiments described above, member resources and affiliate resources, as well as, e.g., POIs, are displayed on the map and available to the user for interaction/communication. As shown in FIGS. 11a and 11b, the user may choose to interact with resources, such as a gold-rated, female member resource 1120 user that matches the user's profile and/or activity/matchmaking preferences and a restaurant affiliate resource 1125. Via the website 1100, the user can view details/profile associated with the resources 1120 and 1125 on the website at window 1130. Additionally, and also as described above in accordance with various embodiments, the user can interact/communicate with affiliate resources, establish an itinerary with the member resource 1120 and one or more affiliate resources, such as affiliate resource 1125, shown on the map 1110.

FIG. 11c illustrates an exemplary implementation of a scheduling/whereabouts feature in accordance with various embodiments. FIG. 11c shows a scheduling/whereabouts GUI 1140 that a member resource can use to indicate when he/she will be engaged in one or more activities, the foreseen activities to be engaged in, and/or the location/whereabouts that the member resource will be. Moreover, such scheduling/whereabouts information may be seen by other resources and/or incorporated into an itinerary as described above, so that the other resource(s) may plan contact/interactions and/or create itineraries for a meeting accordingly. It should be noted that a user can configure his/her schedule/whereabouts either on the fly in real-time via, e.g., a mobile device, or through the matchmaking website.

FIG. 11d illustrates an exemplary itinerary 1150 created by a user. For example, itinerary 1150 indicates that the user and at least one other member resource are scheduled to be at dinner at the “Silo Restaurant” from 7 pm-9 pm, dancing at the “Rose Dance Club” between 9 pm and 12 am, and retiring at the “Western Sunset Hotel” from 12 am on. Additionally, the itinerary 1150 can contain links (e.g., hyperlinks) to the member/affiliate's profile or details, website, etc. Additionally, the other member resource can see/interact with the itinerary 1150 by, e.g., accepting an activity, a location of the activity, and when the activity is to take place, as well as submit feedback, such as suggesting another location for the user's scheduled activity.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Moreover, modules may include hardware, routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a mobile device or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. It will be further appreciated that the system and method described herein may perform fewer or additional functions as compared to those described herein. For example, an entity that performs and/or utilizes only some of the above-mentioned processes may use a computer system that contains only a subset of the functions described herein. Additionally, one or more of the systems or functions described above may be variously combined in alternative configurations.

What is claimed is:

1. A method of mobile match mapping, comprising:
mapping in real-time, a local activity scene based on a location of a user;
presenting respective locations and characteristics of at least one member resource and at least one affiliate resource;
constantly and dynamically updating the local activity scene including at least one of the respective locations of the at least one member resource and the at least one affiliate resource in relation to the location of the user;
enabling navigation of the local activity scene to effectuate at least one of an interaction with at least one of the at least one member resource and the at least one affiliate resource, and planning a meeting involving the at least one member resource and the at least one affiliate resource; and
upon the planning of the meeting, generating an activity itinerary.

2. The method of claim 1, wherein the presenting comprises presenting a map on a mobile device.

3. The method of claim 1, wherein the presenting comprises presenting a map on a webpage.

4. The method of claim 1, wherein the location of the user is a future location.

5. The method of claim 1, wherein the planning of the meeting comprises contacting the at least one affiliate resource regarding usage of at least one of a service and good provided by the at least one affiliate resource.

6. The method of claim 1, further comprising enabling the navigation of the local activity scene to effectuate the at least one of the interaction and the planning with at least a second member resource.

7. The method of claim 1, wherein the presenting of the respective locations and characteristics of the at least one member resource and the at least one affiliate resource is dependent upon the characteristics of the at least one member resource and the at least one affiliate resource matching at least one of a profile and a preference of the user.

8. The method of claim 1 further comprising, updating the characteristics of at least one of the at least one member resource and the least one affiliate resource.

9. The method of claim 8, wherein the updating of the characteristics comprises updating a status of at least one of the at least one member resource and the at least one affiliate resource.

10. The method of claim 9, wherein the status comprises one of a viewer status and a resource status.

11. The method of claim 1, wherein the characteristics comprise one of a shortened summary of details and complete details associated with at least one of the at least one member resource and the at least one affiliate resource.

12. The method of claim 1, further comprising prioritizing the at least one member resource and the at least one affiliate resource according to qualitative variables.

13. The method of claim 12, wherein the qualitative variables comprise subjective rankings attributed to at least one of the at least one member resource and the at least one affiliate resource by at least one of another member resource and another affiliate resource.

14. The method of claim 1, further comprising displaying targeted advertising to the user.

15. The method of claim 1, further comprising enabling scheduling at least one of availability and whereabouts of at least one of the user and the member resource.

16. The method of claim 1, further comprising storing a favorites list indicative of at least one of a favorite location and a favorite activity to be engaged in at the favorite location, wherein the favorites list is accessible to at least one of the at least one member resource and the at least one affiliate resource.

17. A computer program product, comprising computer code configured to perform the processes of claim 1.

18. A system for mobile match mapping, comprising:
a mobile device hosting a mobile matchmaking application configured to:
display a dynamically updatable real-time and interactive map of a local activity scene based upon retrieved location information associated with a user;
populate the map with identifiers indicative of respective locations and characteristics of at least one member resource and at least one affiliate resource; and
enable navigation of the dynamically updatable real-time and interactive map to effectuate at least one of an interaction between the user, the at least one member resource, and the at least one affiliate resource, and planning a meeting involving the user, the at least one member resource, and the at least one affiliate resource; and
a matchmaking server operatively connected to the mobile matchmaking application, wherein the matchmaking server is configured to:
provide the mobile matchmaking application with the respective locations and characteristics of at least one member resource and at least one affiliate resource displayed on the real-time and interactive map; and
host a web-based matchmaking web service configured to operate in conjunction with the mobile matchmaking application.

19. The system of claim 18, wherein the location information associated with the user is indicative of a future location.

20. The system of claim 18, wherein the mobile matchmaking application is further configured to update a status of the user, the status comprising one of a viewer status and a resource status.

21. The system of claim 18, wherein the mobile matchmaking application is further configured to prioritize the at least one member resource and the at least one affiliate resource according to qualitative variables.

22. The system of claim 21, wherein the qualitative variables comprise subjective rankings attributed to at least one of the at least one member resource and the at least one affiliate resource by at least one of another member resource and another affiliate resource.
